(19) United States
(12) Patent Application Publication
(10) Pub. No.: US 2021/0385493 A1
(43) Pub. Date: Dec. 9, 2021

(54) METHODS AND APPARATUS FOR COMPRESSION FEEDBACK FOR OPTIMAL BANDWIDTH

(71) Applicant: QUALCOMM Incorporated, San Diego, CA (US)

(72) Inventors: Dileep MARCHYA, Hyderabad (IN); Dhaval Kanubhai PATEL, San Diego, CA (US); Gary Arthur CIAMBELLA, Newmarket (CA); Xian Chi Bobby MAN, Vaughan (CA)

(21) Appl. No.: 16/892,170

(22) Filed: Jun. 3, 2020

(51) Int. Cl. H04N 19/61; H04N 19/172; H04N 19/44; H04N 19/63

(52) U.S. Cl. CPC H04N 19/61; H04N 19/63; H04N 19/44; H04N 19/172

(57) ABSTRACT

The present disclosure relates to methods and apparatus for display processing. The apparatus can calculate a bandwidth compression ratio (CR) for each of a plurality of tile rows in one or more layers in a frame, each of the one or more layers being associated with one or more regions in the frame. The apparatus can also determine a bandwidth CR for each of the one or more regions associated with each of the one or more layers based on the calculated bandwidth CR for the plurality of tile rows in the one or more layers. Additionally, the apparatus can determine a total bandwidth for the frame based on the determined bandwidth CR for each of the one or more regions associated with the one or more layers. The apparatus can also calculate a total bandwidth for each of the one or more regions.

### TECHNICAL FIELD

The present disclosure relates generally to processing systems and, more particularly, to one or more techniques for display or graphics processing.

### INTRODUCTION

Computing devices often utilize a graphics processing unit (GPU) to accelerate the rendering of graphical data for display. Such computing devices may include, for example, computer workstations, mobile phones such as so-called smartphones, embedded systems, personal computers, tablet computers, and video game consoles. GPUs execute a graphics processing pipeline that includes one or more processing stages that operate together to execute graphics processing commands and output a frame. A central processing unit (CPU) may control the operation of the GPU by issuing one or more graphics processing commands to the GPU. Modern day CPUs are typically capable of concurrently executing multiple applications, each of which may need to utilize the GPU during execution. A device that provides content for visual presentation on a display generally includes a GPU.

Typically, a GPU of a device is configured to perform the processes in a graphics processing pipeline. However, with the advent of wireless communication and smaller, handheld devices, there has developed an increased need for improved graphics processing.

### SUMMARY

The following presents a simplified summary of one or more aspects in order to provide a basic understanding of such aspects. This summary is not an extensive overview of all contemplated aspects, and is intended to neither identify key elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a display processor, a display processing unit (DPU), a GPU, or a CPU. The apparatus may determine one or more regions associated with one or more layers in a frame. The apparatus may also configure a plurality of tile rows in the one or more layers in the frame. Additionally, the apparatus may calculate a bandwidth compression ratio (CR) for each of a plurality of tile rows in one or more layers in a frame, where each of the one or more layers may be associated with one or more regions in the frame. The apparatus may also overlay each of the plurality of tile rows with an adjacent tile row of the plurality of tile rows in the one or more layers. The apparatus may also determine a minimum bandwidth CR for the plurality of tile rows in each of the one or more regions associated with each of the one or more layers. Further, the apparatus may determine a bandwidth CR for each of the one or more regions associated with each of the one or more layers based on the calculated bandwidth CR for the plurality of tile rows in the one or more layers. The apparatus may also communicate the determined bandwidth CR for each of the one or more regions associated with each of the one or more layers. The apparatus may also determine whether each of the one or more layers is a non-updating layer or an updating layer. Moreover, the apparatus may calculate a total bandwidth for each of the one or more regions associated with each of the one or more layers based on the determined bandwidth CR for each of one or more regions associated with each of the one or more layers. The apparatus may also combine the calculated total bandwidth for each of the one or more regions in the one or more layers. The apparatus may also determine a total bandwidth for the frame based on the determined bandwidth CR for each of the one or more regions associated with the one or more layers. The apparatus may also monitor a bandwidth CR for each of the one or more regions associated with each of the one or more layers over a time period when each of the one or more layers is an updating layer.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram that illustrates an example content generation system in accordance with one or more techniques of this disclosure.

FIG. 2 illustrates an example GPU in accordance with one or more techniques of this disclosure.

FIGS. 3A and 3B illustrate example diagrams in accordance with one or more techniques of this disclosure.

FIG. 4 illustrates an example diagram in accordance with one or more techniques of this disclosure.

FIGS. 5A and 5B illustrate example diagrams in accordance with one or more techniques of this disclosure.

FIG. 6 illustrates an example diagram in accordance with one or more techniques of this disclosure.

FIG. 7 illustrates an example flowchart of an example method in accordance with one or more techniques of this disclosure.

### DETAILED DESCRIPTION

In display processing, there may be a number of tile rows within each region in each layer in a frame or display. Also, a frame or display can include a number of regions which can be associated with the different layers. The image content in each section or region of a layer can correspond to a different compression ratio. In some aspects, the aggregation of all layers with a minimum CR across all tile rows may correspond to a sub-optimal bandwidth vote. Also, a display may utilize a worst-case compression ratio for some of the layers in a frame. By doing so, this can lead to an increased bandwidth vote for the frame. Further, a DDR bandwidth can be calculated based on a worst-case compression ratio, which may not optimize the display bandwidth vote. In some aspects, the worst-case compression ratio may be equal to a lowest compression ratio, which can correspond to a higher bandwidth vote. This higher bandwidth vote may lead to a higher power consumption. Aspects of the present disclosure can calculate or determine the compression ratio in order to optimize a display bandwidth vote or request. In turn, the present disclosure can optimize the power consumption of a display. As such, the present disclosure can optimize a display bandwidth vote or request based on a bandwidth compression ratio of a layer or region in a frame. Additionally, aspects of the present disclosure can include a DPU hardware enhancement to measure a worst-case tile row compression in a specified region of a layer or frame. The DPU hardware can feedback this information to a software driver, which can be used in subsequent frames to compute the actual bandwidth, rather than utilize the worst-case bandwidth.

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOC), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application, i.e., software, being configured to perform one or more functions. In such examples, the application may be stored on a memory, e.g., on-chip memory of a processor, system memory, or any other memory. Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

In general, this disclosure describes techniques for having a graphics processing pipeline in a single device or multiple devices, improving the rendering of graphical content, and/or reducing the load of a processing unit, i.e., any processing unit configured to perform one or more techniques described herein, such as a GPU. For example, this disclosure describes techniques for graphics processing in any device that utilizes graphics processing. Other example benefits are described throughout this disclosure.

As used herein, instances of the term “content” may refer to “graphical content,” “image,” and vice versa. This is true regardless of whether the terms are being used as an adjective, noun, or other parts of speech. In some examples, as used herein, the term “graphical content” may refer to a content produced by one or more processes of a graphics processing pipeline. In some examples, as used herein, the term “graphical content” may refer to a content produced by a processing unit configured to perform graphics processing. In some examples, as used herein, the term “graphical content” may refer to a content produced by a graphics processing unit.

In some examples, as used herein, the term “display content” may refer to content generated by a processing unit configured to perform displaying processing. In some examples, as used herein, the term “display content” may refer to content generated by a display processing unit. Graphical content may be processed to become display content. For example, a graphics processing unit may output graphical content, such as a frame, to a buffer (which may be referred to as a framebuffer). A display processing unit may read the graphical content, such as one or more frames from the buffer, and perform one or more display processing techniques thereon to generate display content. For example, a display processing unit may be configured to perform composition on one or more rendered layers to generate a frame. As another example, a display processing unit may be configured to compose, blend, or otherwise combine two or more layers together into a single frame. A display processing unit may be configured to perform scaling, e.g., upscaling or downscaling, on a frame. In some examples, a frame may refer to a layer. In other examples, a frame may refer to two or more layers that have already been blended together to form the frame, i.e., the frame includes two or more layers, and the frame that includes two or more layers may subsequently be blended.

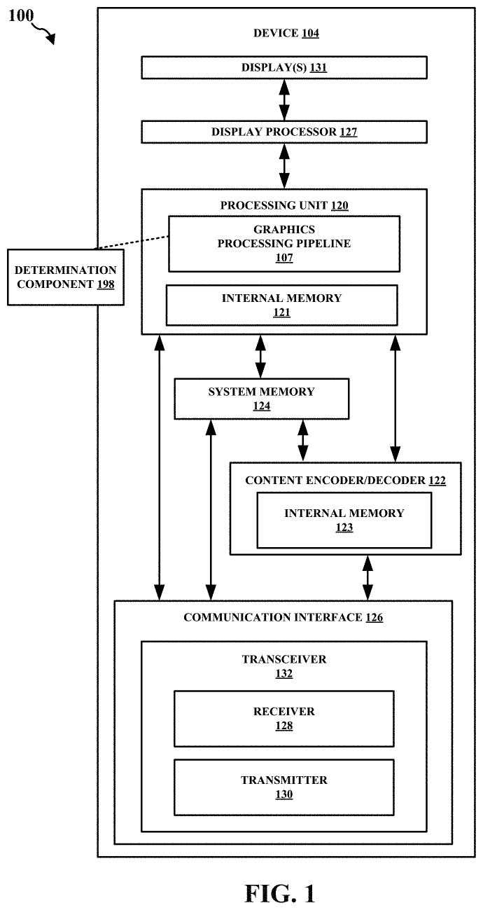

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of an SOC. The device 104 may include one or more components configured to perform one or more techniques of this disclosure. In the example shown, the device 104 may include a processing unit 120, a content encoder/decoder 122, and a system memory 124. In some aspects, the device 104 can include a number of optional components, e.g., a communication interface 126, a transceiver 132, a receiver 128, a transmitter 130, a display processor 127, and one or more displays 131. Reference to the display 131 may refer to the one or more displays 131. For example, the display 131 may include a single display or multiple displays. The display 131 may include a first display and a second display. The first display may be a left-eye display and the second display may be a right-eye display. In some examples, the first and second display may receive different frames for presentment thereon. In other examples, the first and second display may receive the same frames for presentment thereon. In further examples, the results of the graphics processing may not be displayed on the device, e.g., the first and second display may not receive any frames for presentment thereon. Instead, the frames or graphics processing results may be transferred to another device. In some aspects, this can be referred to as split-rendering.

The processing unit 120 may include an internal memory 121. The processing unit 120 may be configured to perform graphics processing, such as in a graphics processing pipeline 107. The content encoder/decoder 122 may include an internal memory 123. In some examples, the device 104 may include a display processor, such as the display processor 127, to perform one or more display processing techniques on one or more frames generated by the processing unit 120 before presentment by the one or more displays 131. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of: a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 and the content encoder/decoder 122 may be communicatively coupled to the system memory 124 over a bus. In some examples, the processing unit 120 and the content encoder/decoder 122 may be communicatively coupled to each other over the bus or a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, SRAM, DRAM, erasable programmable ROM (EPROM), electrically erasable programmable ROM (EEPROM), flash memory, a magnetic data media or an optical storage media, or any other type of memory.

The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a central processing unit (CPU), a graphics processing unit (GPU), a general purpose GPU (GPGPU), or any other processing unit that may be configured to perform graphics processing. In some examples, the processing unit 120 may be integrated into a motherboard of the device 104. In some examples, the processing unit 120 may be present on a graphics card that is installed in a port in a motherboard of the device 104, or may be otherwise incorporated within a peripheral device configured to interoperate with the device 104. The processing unit 120 may include one or more processors, such as one or more microprocessors, GPUs, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 can include an optional communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the graphics processing pipeline 107 may include a determination component 198 configured to determine one or more regions associated with one or more layers in a frame. The determination component 198 can also be configured to configure a plurality of tile rows in the one or more layers in the frame. The determination component 198 can also be configured to calculate a bandwidth compression ratio (CR) for each of a plurality of tile rows in one or more layers in a frame, where each of the one or more layers may be associated with one or more regions in the frame. The determination component 198 can also be configured to overlay each of the plurality of tile rows with an adjacent tile row of the plurality of tile rows in the one or more layers. The determination component 198 can also be configured to determine a minimum bandwidth CR for the plurality of tile rows in each of the one or more regions associated with each of the one or more layers. The determination component 198 can also be configured to determine a bandwidth CR for each of the one or more regions associated with each of the one or more layers based on the calculated bandwidth CR for the plurality of tile rows in the one or more layers. The determination component 198 can also be configured to communicate the determined bandwidth CR for each of the one or more regions associated with each of the one or more layers. The determination component 198 can also be configured to determine whether each of the one or more layers is a non-updating layer or an updating layer. The determination component 198 can also be configured to calculate a total bandwidth for each of the one or more regions associated with each of the one or more layers based on the determined bandwidth CR for each of one or more regions associated with each of the one or more layers. The determination component 198 can also be configured to combine the calculated total bandwidth for each of the one or more regions in the one or more layers. The determination component 198 can also be configured to determine a total bandwidth for the frame based on the determined bandwidth CR for each of the one or more regions associated with the one or more layers. The determination component 198 can also be configured to monitor a bandwidth CR for each of the one or more regions associated with each of the one or more layers over a time period when each of the one or more layers is an updating layer.

As described herein, a device, such as the device 104, may refer to any device, apparatus, or system configured to perform one or more techniques described herein. For example, a device may be a server, a base station, user equipment, a client device, a station, an access point, a computer, e.g., a personal computer, a desktop computer, a laptop computer, a tablet computer, a computer workstation, or a mainframe computer, an end product, an apparatus, a phone, a smart phone, a server, a video game platform or console, a handheld device, e.g., a portable video game device or a personal digital assistant (PDA), a wearable computing device, e.g., a smart watch, an augmented reality device, or a virtual reality device, a non-wearable device, a display or display device, a television, a television set-top box, an intermediate network device, a digital media player, a video streaming device, a content streaming device, an in-car computer, any mobile device, any device configured to generate graphical content, or any device configured to perform one or more techniques described herein. Processes herein may be described as performed by a particular component (e.g., a GPU), but, in further embodiments, can be performed using other components (e.g., a CPU), consistent with disclosed embodiments.

GPUs can process multiple types of data or data packets in a GPU pipeline. For instance, in some aspects, a GPU can process two types of data or data packets, e.g., context register packets and draw call data. A context register packet can be a set of global state information, e.g., information regarding a global register, shading program, or constant data, which can regulate how a graphics context will be processed. For example, context register packets can include information regarding a color format. In some aspects of context register packets, there can be a bit that indicates which workload belongs to a context register. Also, there can be multiple functions or programming running at the same time and/or in parallel. For example, functions or programming can describe a certain operation, e.g., the color mode or color format. Accordingly, a context register can define multiple states of a GPU.

Context states can be utilized to determine how an individual processing unit functions, e.g., a vertex fetcher (VFD), a vertex shader (VS), a shader processor, or a geometry processor, and/or in what mode the processing unit functions. In order to do so, GPUs can use context registers and programming data. In some aspects, a GPU can generate a workload, e.g., a vertex or pixel workload, in the pipeline based on the context register definition of a mode or state. Certain processing units, e.g., a VFD, can use these states to determine certain functions, e.g., how a vertex is assembled. As these modes or states can change, GPUs may need to change the corresponding context. Additionally, the workload that corresponds to the mode or state may follow the changing mode or state.

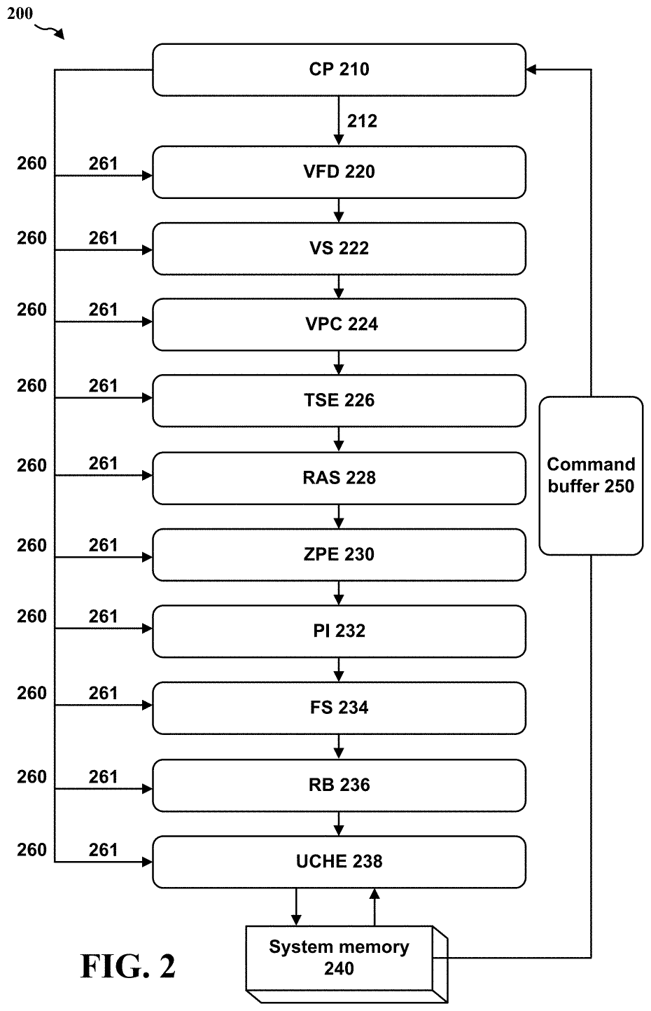

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, L2 cache (UCHE) 238, and system memory 240. Although FIG. 2 displays that GPU 200 includes processing units 220-238, GPU 200 can include a number of additional processing units. Additionally, processing units 220-238 are merely an example and any combination or order of processing units can be used by GPUs according to the present disclosure. GPU 200 also includes command buffer 250, context register packets 260, and context states 261.

As shown in FIG. 2, a GPU can utilize a CP, e.g., CP 210, or hardware accelerator to parse a command buffer into context register packets, e.g., context register packets 260, and/or draw call data packets, e.g., draw call packets 212. The CP 210 can then send the context register packets 260 or draw call data packets 212 through separate paths to the processing units or blocks in the GPU. Further, the command buffer 250 can alternate different states of context registers and draw calls. For example, a command buffer can be structured in the following manner: context register of context N, draw call(s) of context N, context register of context N+1, and draw call(s) of context N+1.

Display processing units (DPUs) can be included in a number of different display devices, e.g., smart phones. In some aspects, DPUs can be utilized to determine certain bandwidth, e.g., double data rate (DDR) bandwidth, as a DPU can blend and transfer data to a display panel for each line in a fixed line time. Display bandwidth requests or selections, i.e., display bandwidth votes, can account for total number of pixels that may need to fetched to produce a line in a frame or display. Thus, the display bandwidth request or vote can increase in proportion to a total number of overlapping layers in a frame or display.

In some aspects, a display bandwidth vote can be a request from the DPU for an amount of display bandwidth from the display hardware. For instance, a display bandwidth vote can be a request for an increase in bandwidth for a corresponding increase in voltage or power. For example, a display bandwidth vote can be based on a number of overlaps (num_overlaps), a frame rate (frame_rate), a vertical active amount (vertical_active), a horizontal active amount (horizontal_active), and a number of bytes per pixel (bytes_per_pixel). As an equation, display bandwidth vote=num_overlaps*frame_rate*vertical_active*horizontal_active*bytes_per_pixel. For example, a home screen display can include the following display bandwidth vote: display bandwidth vote=4*60*1440*2560*4=3.3 gigabytes per second (Gbps), e.g., on 1440×2560 display at 60 Hz.

Some aspects of bandwidth compression, e.g., universal bandwidth compression (UBWC), can compress pixels which may help to reduce the total bytes fetched from DDR bandwidth. A display subsystem can effectively reduce the amount of display bandwidth votes based on a bandwidth compression ratio (CR). However, due to an asynchronous nature of the software pipeline, a GPU can render frames in parallel to a display pipeline setup. Accordingly, bandwidth compression statistics may not be available at the time of composition decisions or a bandwidth computation in the display software. Also, display software can consider a constant compression ratio, e.g., a CR of 1.26, based on use case simulations. As such, in some aspects, a display bandwidth vote can be divided by 1.26. For example, on home screen display, the display bandwidth vote can be equal to: 3.3 Gbps/1.26=2.6 Gbps on a 1440×2560 display at 60 Hz.

In some aspects, a DDR bandwidth can be calculated based on a minimum or lowest compression ratio, i.e., a worst-case compression ratio. As such, the worst-case compression ratio may be equal to a low compression ratio, which can correspond to a high bandwidth vote. The DPU software can perform a display bandwidth vote or request calculation based on this worst-case compression ratio.

Additionally, the display can include a number of layers in a frame. For example, the display can include a wallpaper or background layer, a launcher or foreground layer, a status bar, a navigation bar, a round top bar, and a round bottom bar. In some aspects, the measured compression ratio for each of these display layers can be higher than the worst-case compression ratio. Accordingly, the measured compression ratio can correspond to a lower bandwidth vote than the worst-case compression ratio.

In some aspects, a compression ratio (CR) can depend on an amount of pixel data. Also, the compression ratio can be different for each tile row in a frame. For instance, the display can determine the minimum CR across all tile rows in a frame. The display can also consider the minimum CR for a bandwidth calculation for the given frame. Further, the display can aggregate the minimum CRs for each layer in the frame to calculate a final bandwidth vote for the frame. For example, on a home screen display, a display bandwidth vote can be equal to: 1.14 Gbps on 1440×2560 display at 60 Hz display. This calculation can consider the actual bandwidth compression ratios.

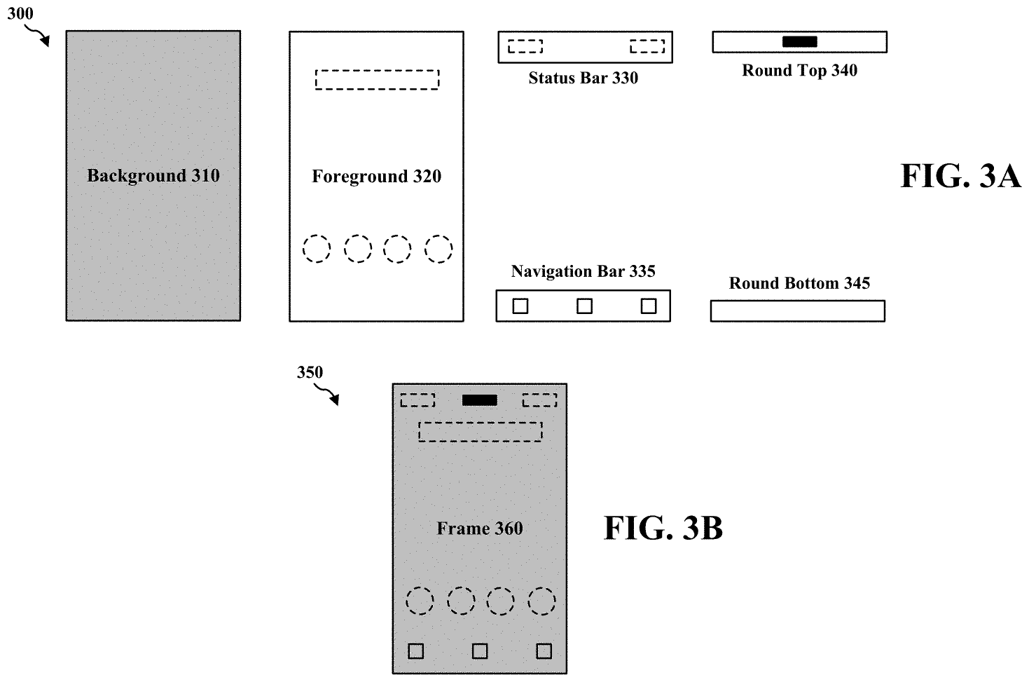

FIGS. 3A and 3B illustrate diagrams 300 and 350, respectively, in accordance with one or more techniques of this disclosure. As shown in FIG. 3A, diagram 300 can include a number of different components or layers, such as a background layer or wallpaper 310, a foreground layer or launcher 320, a status bar layer 330, a navigation bar layer 335, a round top layer 340, and a round bottom layer 345. As shown in FIG. 3B, diagram 350 includes frame 360, which can include each of the layers shown in diagram 300.

Each of the layers shown in FIG. 3A can include a number of different bandwidth compression ratios. Additionally, different regions or sections in each layer can include a different bandwidth CR. For example, background layer 310 can include a different bandwidth CR in a different region or section of the layer. This can also correspond to foreground layer 320, status bar layer 330, navigation bar layer 335, round top layer 340, and/or round bottom layer 345. Accordingly, each layer in a frame or display can include different compression ratios that correspond to different regions in the layer. For example, one region in background layer 310 can include a bandwidth CR of 1.94, while another region may include a bandwidth CR of 2.96 or 3.76.

In some aspects, there may be a number of tile rows within each region in each layer in a frame or display. Additionally, there can be a number of lines within each tile row in a layer. As such, a frame or display can include a number of different layers, which can each include a number of regions or sections, which can include a number of tile rows. Also, a frame or display can include a number of regions which can be associated with the different layers. Accordingly, each layer can be associated with the same region in the frame as other layers.

As indicated above, the image content in each section or region of a layer can correspond to a different compression ratio. If the image content or pixel colors for a region is solid or unchanging, then the bandwidth compression ratio may be high, e.g., a bandwidth CR of 3.76. As such, a low disparity between adjacent pixels may correspond to a higher compression ratio. If the image content or pixel colors for a region vary or change, then the compression ratio may be low, e.g., a bandwidth CR of 1.94. Accordingly, a high disparity between adjacent pixels may correspond to a lower bandwidth compression ratio.

In some aspects, the aggregation of all layers with a minimum CR across all tile rows may correspond to a sub-optimal bandwidth vote. This information can be obtained from the DPU hardware. In some instances, tile rows in certain layers, e.g., a wallpaper or launcher layer, may have an improved compression in an area that overlaps with another layer, e.g., a status bar layer, navigation bar layer, and/or round corner or round top and bottom layers. This may be due to the top or bottom of the wallpaper or launcher layer overlapping with these other layers, e.g., status bar layer, navigation bar layer, and round top or bottom layers. In some aspects, a display can reduce a bandwidth vote by a certain amount of Gbps, e.g., 0.95 Gbps, if compression ratios in overlapping regions are factored.

In some aspects, a display may utilize a worst-case compression ratio for some of the layers in a frame. By doing so, this can lead to an increased bandwidth vote for the frame. Moreover, an increased bandwidth vote for a frame may lead to a variety of different scenarios, such as a voltage corner shift in multiple use cases.

As indicated herein, a DDR bandwidth can be calculated based on a worst-case compression ratio, which may not optimize the display bandwidth vote. In some aspects, the worst-case compression ratio may be equal to a minimum or lowest compression ratio, which can correspond to a higher bandwidth vote. This higher bandwidth vote may lead to a higher power consumption. However, the bandwidth compression may be performing better than expected, i.e., better than the worst-case compression ratio, so the actual compression ratio may be higher than expected. Based on this, there is a present need calculate or determine the compression ratio in order to optimize a display bandwidth vote or request. By doing so, the power consumption of a display can be optimized.

Aspects of the present disclosure can calculate or determine the compression ratio in order to optimize a display bandwidth vote or request. In turn, the present disclosure can optimize the power consumption of a display. As such, the present disclosure can optimize a display bandwidth vote or request based on a bandwidth compression ratio of a layer or region in a frame. Additionally, aspects of the present disclosure can include a DPU hardware enhancement to measure a worst-case tile row compression in a specified region of a layer or frame. The DPU hardware can feedback this information to a software driver, which can be used in subsequent frames to compute the actual bandwidth, rather than utilize the worst-case bandwidth.

In some aspects, the compression ratio information can be obtained by display software from the DPU hardware. The DDR bandwidth vote or request may be adjusted based on this information. So the present disclosure can retrieve bandwidth compression information or statistics from the DPU hardware and request or vote for the optimal bandwidth.

Aspects of the present disclosure can include a DPU hardware enhancement. For instance, a bandwidth check module may be implemented for each pipe rectangle near an interface, e.g., a virtualizing bus interface (VBIF), in order to measure actual requests. The bandwidth check module may collect two types of bandwidth measurements, such as the worst-case tile row bandwidth, i.e., an instantaneous bandwidth, and the total frame bandwidth, i.e., the average bandwidth of each region in the frame. As mentioned above, a worst-case tile row bandwidth may correspond to a high bandwidth and high amount of bytes being fetched from the DDR memory, which can correspond to a low compression ratio.

In some aspects, the bandwidth conditions or bandwidth specifications for each region in a layer or frame may be measured in beats. Also, the burst size signal on a VBIF may be used to acquire these measurements. The hardware implementation for one frame operation for a single rectangle may be a number of different implementations. For instance, the DPU hardware may allow the software to configure a number of regions in a layer or frame.

In some aspects, at the start of a frame, the DPU hardware can reset any counters and/or measurements. For each burst transaction in a particular region, the DPU hardware can keep a running count of the number of burst beats until a certain signal, e.g., a last X (LAST_X) signal. Also, the DPU hardware can keep a running count of the number of burst beats until the next frame. At the LAST_X signal, the counter value can be the total bandwidth for the current tile row. The current tile row bandwidth may then be compared with the worst-case tile row bandwidth in order to update the value, if appropriate, i.e., obtain the maximum value of the two values. In some aspects, the y-coordinate of the worst-case tile row may also be updated. The DPU hardware can also reset the counter and repeat the process tile row by tile row until the end of frame. At end of the frame, the DPU hardware can update the feedback measurement registers. In some aspects, the DPU hardware can store the information for each region in the frame, e.g., independent from other regions.

As indicated herein, aspects of the present disclosure can maintain a running count of the bandwidth for each tile row and for each region in a layer or frame. In some aspects, the present disclosure can determine the worst-case tile row compression ratio in a given region in the frame. Also, the display software can program the region in which it is interested in determining the compression ratio. For example, if there are a number of tile rows in a region, and each of the tile rows include a compression ratio of 3× or 4×, then the present disclosure may be interested in the tile rows with a 3× compression ratio.

In some aspects, the worst-case bandwidth specification or condition for each region can be obtained from the DPU hardware. As the frame is being processed, the DPU hardware can detect or calculate the bandwidth per tile row. At the end of the frame, the DPU hardware can inform the display software of the calculation. For example, if an image includes 100 tile rows per region of a layer, the present disclosure can determine the compression ratio for each of the tile rows in the region.

Additionally, the present disclosure can determine a minimum or lowest compression ratio of each tile row in a layer. This minimum or lowest compression ratio of the tile rows may correspond to a minimum bandwidth that may be needed for the entire region. This can include each of the tile rows to be processed. As such, the bandwidth compression ratio can be calculated for each tile row in a region. Then the present disclosure can determine the lowest compression ratio of the tile rows in that region. This compression can be factored when calculating an overall bandwidth for a frame.

In some aspects, the DPU hardware can support the programming of multiple y-coordinates, e.g., an amount N of y-coordinates, where multiple horizontal lines, e.g., an amount N of horizontal lines, can divide the whole frame into a number of non-overlapping regions, e.g., N+1 non-overlapping regions, from top to bottom. For each region, the DPU hardware may retrieve a worst-case tile row bandwidth measurement, the y-coordinate of the worst-case tile row, and a total bandwidth measurement of the region.

Once the DPU hardware has determined a compression ratio for each region in a layer, the display software of the present disclosure can implement different types of algorithms. For instance, the present disclosure can implement a deterministic algorithm where bandwidth votes are computed based on an actual bandwidth CR for non-updating layers and a constant bandwidth CR for updating layers. Also, the present disclosure can implement a probabilistic algorithm where bandwidth votes are approximated based on heuristics for updating layers which can follow certain types of patterns.

In the deterministic algorithm, the display software can determine the overlapping regions, program y-coordinates for each of the layers, read worst-case tile row CRs, and consider actual CRs for non-updating layers and constant CRs for updating layers in subsequent cycles for bandwidth computations. Many of the layers can refresh at a low frequency and generally remain static, e.g., during home screen panning. For instance, a launcher layer may refresh at 60 fps, while a wallpaper layer, a status bar layer, and a navigation bar layer may generally remain static. Also, the display software may utilize actual CRs retrieved from a DPU hardware for a number of layers in a frame, e.g., a wallpaper layer, a status bar layer, and a navigation bar layer. In subsequent cycles, a constant bandwidth CR, e.g., a bandwidth CR of 1.26, or a recommended compression factor can be utilized for a launcher layer. In a first draw cycle, a display may include a number of different bandwidth votes, e.g., a bandwidth vote of 2.6 Gbps at 60 Hz or a bandwidth vote of 5.2 Gbps at 120 Hz for a 1440×2560 display. In a second draw cycle, a display may include a number of different bandwidth votes, e.g., a bandwidth vote of 1.38 Gbps at 60 Hz or a bandwidth vote of 2.76 Gbps at 120 Hz for a 1440×2560 display. Moreover, a display may utilize this bandwidth vote of 1.38 Gbps or 2.76 Gbps until one of the non-updating layers refreshes again.

A non-updating layer can be a layer that uses a constant image, e.g., a wallpaper or background layer, a status bar layer, a navigation bar layer, a round top layer, and a round bottom layer. For each non-updating layer, the location can be fixed and the lowest compression layer can be provided to the display software. So the display software may receive with the lowest compression ratio information from the DPU hardware, as well as update the bandwidth computation for the non-updating layers. For example, the overall bandwidth for a certain region of a frame can be calculated based on the lowest or minimum compression ratio for that region from a non-updating layer.

An updating layer can updated based on the actions of a user, e.g., a launcher or foreground layer. For instance, an updating layer may have certain icons that can be activated or moved. As indicated above, the DPU hardware can generate the bandwidth compression ratio for each region in each layer, and the display software can calculate the bandwidth value for that region based upon the compression ratio information from the DPU hardware. Also, the DPU can blend each of the layers before sending the layers to a display panel to be displayed. The bandwidth can be determined based on the amount of layers that may need to be blended. For example, blending one amount of layers, e.g., four layers, may result in a certain bandwidth, e.g., 4× bandwidth, while blending another amount of layers, e.g., three layers, may result in another bandwidth, e.g., 3× bandwidth.

Additionally, the regions associated with the layers in a frame can be determined based on the portion of the image that is displayed in each of the layers. For example, if a status bar layer is displayed at the bottom of a frame, then the regions, e.g., three regions, can be determined based on the location of the status bar layer. So the display software can determine the regions prior to any bandwidth compression ratio calculation. In turn, the DPU hardware can blend each of the regions within the layers for the display.

In some aspects, the present disclosure may utilize a minimum or lowest bandwidth compression ratio for each region within an updating layer. This may be because the content for an updating layer is constantly changing, so it may not be efficient to constantly calculate the bandwidth CR for updating layers. As such, the present disclosure can utilize the worst case or lowest bandwidth CR for each region within an updating layer. For non-updating layers, the present disclosure may utilize a calculated bandwidth CR for each region within each non-updating layer. In some aspects, the present disclosure can fetch and/or blend respective data for each region in a layer. Also, the overall bandwidth for the frame may be based on the amount of data that is fetched for each line or region in the frame.

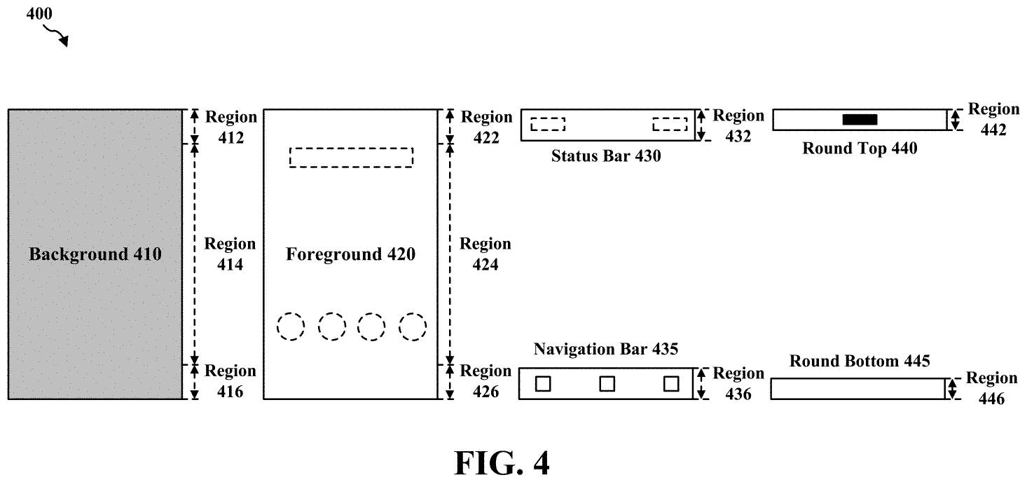

FIG. 4 illustrates diagram 400 in accordance with one or more techniques of this disclosure. As shown in FIG. 4, diagram 400 can include a number of different components or layers. For instance, diagram 400 includes background layer or wallpaper 410, foreground layer or launcher 420, status bar layer 430, navigation bar layer 435, round top layer 440, and round bottom layer 445.

Each of the layers in diagram 400 can correspond to a number of regions or sections. For example, background layer 410 includes region 412, region 414, and region 416. Foreground layer 420 includes region 422, region 424, and region 426. Also, status bar layer 430 includes region 432, navigation bar layer 435 includes region 436, round top layer 440 includes region 442, and round bottom layer 445 includes region 446. Each of these regions can correspond to a region in a frame. For instance, regions 412, 422, 432, and 442 can correspond to the same region in a frame. Also, regions 414 and 424 can correspond to the same region in a frame. Moreover, regions 416, 426, 436, and 446 can correspond to the same region in a frame.

Additionally, each of the layers shown in FIG. 4 can include a number of different bandwidth compression ratios. Also, the different regions in each layer can include a different bandwidth CR. For example, regions 412, 414, and 416 in background layer 410 can each correspond to a different bandwidth CR. Also, regions 422, 424, and 426 in foreground layer 420 can each correspond to a different bandwidth CR. Regions 432, 436, 442, and 446 in status bar layer 430, navigation bar layer 435, round top layer 440, and round bottom layer 445, respectively, can also correspond to different bandwidth CRs. Accordingly, each layer in a frame or display can include different compression ratios that correspond to different regions in the layer. For example, region 412 in background layer 410 can include a bandwidth CR 3.76, while region 414 may include a bandwidth CR of 1.96 and region 416 may include a bandwidth CR of 3.00. Layers with different bandwidth CRs for different regions may be non-updating layers. Also, different regions in a layer may include a similar bandwidth CR. For instance, regions 422, 424, and 426 in foreground layer 420 can each include a bandwidth CR of 1.26. Layers with the same bandwidth CRs for different regions may be updating layers.

As shown in FIG. 4, some layers can correspond to non-updating layers while other layers can correspond to updating layers. For instance, the non-updating layers can be background layer 410, status bar layer 430, navigation bar layer 435, round top layer 440, and round bottom layer 445. The updating layers can be foreground layer 420. Additionally, the bandwidth computation for each region of a frame can be based on whether the layer corresponds to a non-updating layer or an updating layer.

Aspects of the present disclosure can also include probabilistic algorithms. In a probabilistic algorithm, the display software can determine the overlapping regions, program y-coordinates for all the layers, read worst-case or minimum tile row CRs, and/or consider actual CRs for non-updating layers in subsequent cycles for bandwidth computations. So the present disclosure can calculate the bandwidth CR for each region in non-updating layers. As mentioned above, in some aspects, updating layers can utilize a worst-case or minimum bandwidth CR for each region in a layer.

In some instances, the display software can also track a worst-case or minimum tile row CRs in specific regions for updating layers. The display software can also check the variation of CRs across frames for common use cases over a period of time. So the present disclosure can track the history of updates for regions in updating layers over a certain time period. Over the time period, the present disclosure can determine the worst-case or minimum bandwidth CR for regions in updating layers. Based on this, the present disclosure can utilize a learning model for updates over a time period in updating layers. As such, the present disclosure can learn the worst-case compression for an updating layer over a time period, and use this learning model for the bandwidth specification in the future.

In some aspects, if a fluctuation in the bandwidth CR for an updating layer over a time period is within a bandwidth CR range, the fluctuation may be included in the overall bandwidth calculation for the frame. The previous calculations of a bandwidth CR for an updating layer may be used for the overall bandwidth calculation when the fluctuation is outside of a range. So the present disclosure can utilize a bandwidth CR range, and if a bandwidth CR fluctuation is outside of the bandwidth CR range, then the bandwidth CR bandwidth CR may not be utilized in a total frame bandwidth calculation.

Additionally, display software can consider the past worst-case or minimum bandwidth CRs for the layers which have a low fluctuation and consistent pattern of bandwidth CRs across a number of frames over a time period. For example, a home screen launcher layer may have a minimum bandwidth CR of 2.75 in a middle region of the layer and a minimum bandwidth CR of 3.76 in the top and bottom regions of the layer. Further, the display software can consider the heuristics of bandwidth CRs by also allowing for a certain amount of error, e.g., an error rate of 10%. In some instances, a display bandwidth vote can correspond to 0.9 Gbps at 60 Hz and 1.8 Gbps at 120 Hz for a 1440×2560 display. Some layers, e.g., a photo viewer layer or camera layer, can have a high variation in bandwidth CR across different frames. For these layers, the display software can consider a constant bandwidth CR, e.g., a bandwidth CR of 1.26.

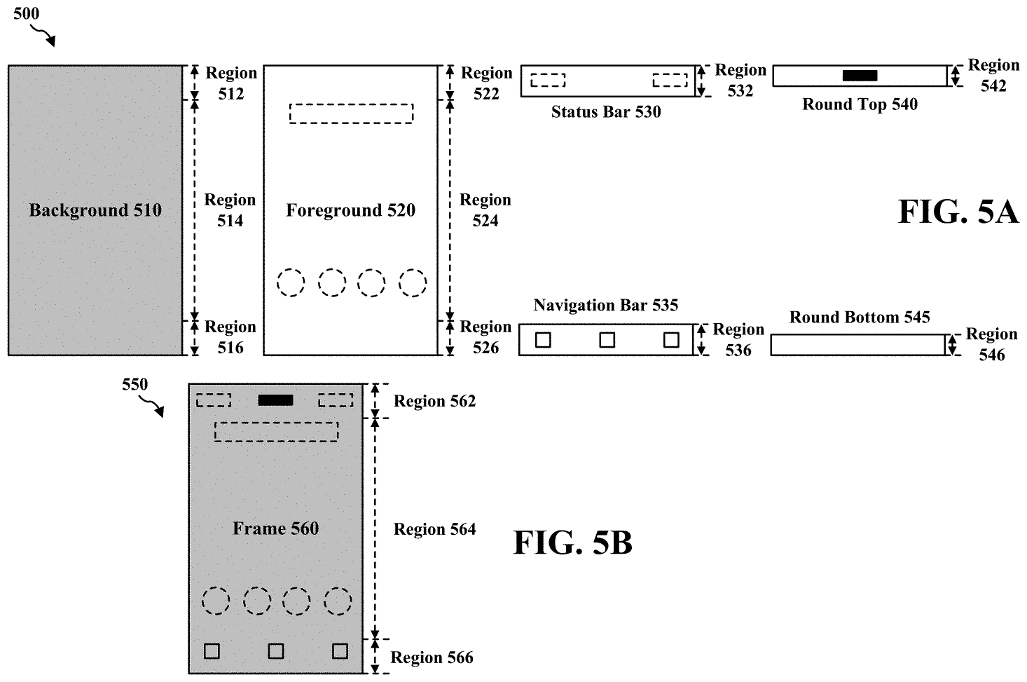

FIGS. 5A and 5B illustrate diagrams 500 and 550, respectively, in accordance with one or more techniques of this disclosure. As shown in FIG. 5A, diagram 500 can include a number of different components or layers, such as background layer or wallpaper 510, foreground layer or launcher 520, status bar layer 530, navigation bar layer 535, round top layer 540, and round bottom layer 545. As shown in FIG. 5B, diagram 550 can include frame 560, which can include each of the layers included in diagram 500.

Each of the layers in diagram 500 can correspond to a number of regions or sections. For example, background layer 510 includes region 512, region 514, and region 516. Foreground layer 520 includes region 522, region 524, and region 526. Also, status bar layer 530 includes region 532, navigation bar layer 535 includes region 536, round top layer 540 includes region 542, and round bottom layer 545 includes region 546. Each of these regions can correspond to region in a frame. For instance, regions 512, 522, 532, and 542 can correspond to the same region in a frame, e.g., region 562 in frame 560. Also, regions 514 and 524 can correspond to the same region in a frame, e.g., region 564 in frame 560. Moreover, regions 516, 526, 536, and 546 can correspond to the same region in a frame, e.g., region 566 in frame 560. Accordingly, the regions in the layers in FIG. 5A can correspond to regions in frame 560 in FIG. 5B.

Further, each of the layers shown in FIG. 5A can include a number of different bandwidth compression ratios. The different regions in each layer can include a different bandwidth CR. For example, regions 512, 514, and 516 in background layer 510 can each correspond to a different bandwidth CR. Also, regions 522, 524, and 526 in foreground layer 520 can each correspond to a different bandwidth CR. Regions 532, 536, 542, and 546 in status bar layer 530, navigation bar layer 535, round top layer 540, and round bottom layer 545, respectively, can also correspond to different bandwidth CRs. Accordingly, each layer in a frame or display can include different compression ratios that correspond to different regions in the layer. For example, region 512 in background layer 510 can include a bandwidth CR of 3.76, while region 514 may include a bandwidth CR of 1.96 and region 516 may include a bandwidth CR of 3.00. Layers with different bandwidth CRs for different regions may be non-updating layers. Also, different regions in a layer may include a similar bandwidth CR. For instance, region 522, 524, and 526 in foreground layer 520 can each include a bandwidth CR of 3.76. Layers with the same bandwidth CRs for different regions may be updating layers. However, in the probabilistic algorithm mentioned above, one region in an updating layer may include a different bandwidth CR, e.g., region 524 in foreground layer 520 may include a bandwidth CR of 2.47.

As shown in FIG. 5, some layers can correspond to non-updating layers while other layers can correspond to updating layers. For instance, the non-updating layers can be background layer 510, status bar layer 530, navigation bar layer 535, round top layer 540, and round bottom layer 545. The updating layers can be foreground layer 520. Additionally, the bandwidth computation for each region of a frame can be based on whether the layer corresponds to a non-updating layer or an updating layer. For example, the bandwidth computation for region 562, region 564, and region 566 can be based on whether layers 510, 520, 530, 535, 540, and 545 are non-updating or updating layers. As such, the total bandwidth computation for frame 560 can be based on whether layers 510, 520, 530, 535, 540, and 545 are non-updating or updating layers.

Aspects of the present disclosure can also compare the bandwidth vote or request for a number of different bandwidth CR approaches, e.g., a constant CR approach, a deterministic CR approach, and a probabilistic CR approach. For example, one such use case can be a home screen in a display or a panning of a home screen in a display. As further indicated herein, the present disclosure can consider a number of layers in a frame. These layers can include a wallpaper or background layer, which may be non-updating or static, and a launcher or foreground layer, which may be updating or refreshing at a panel refresh rate, e.g., 60 fps or 120 fps. The present disclosure can also consider a status bar layer, which can be updating or refreshing at 1 fps, as well as a navigation bar layer, which can be non-updating or static.

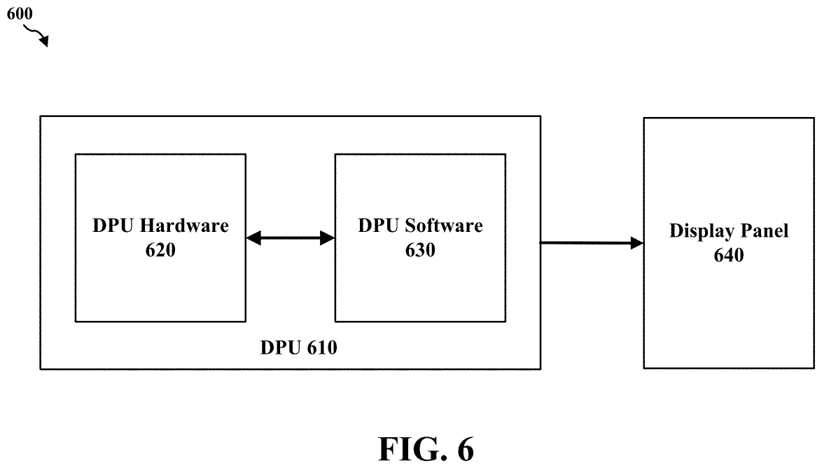

FIG. 6 illustrates diagram 600 in accordance with one or more techniques of this disclosure. As shown in FIG. 6, diagram 600 includes DPU 610, which can include DPU hardware 620 and DPU software 630. Additionally, diagram 600 includes display panel 640. As shown in FIG. 6, DPU 610 can communicate with display panel 640. FIG. 6 illustrates some of the components that the present disclosure may utilize for the display processing techniques mentioned herein.

FIGS. 3A-6 illustrate examples of the aforementioned processes of display processing. As shown in FIGS. 3A-6, aspects of the present disclosure, such as display processors, display processing units (DPUs), DPU hardware, DPU software, GPUs, or CPUs, e.g., DPU 610, DPU hardware 620, or DPU software 630, can perform a number of different steps or processes to perform the aforementioned compression feedback in display processing. For instance, DPUs herein, e.g., DPU 610, may determine one or more regions, e.g., regions 562, 564, 566, associated with one or more layers, e.g., layers 510, 520, 530, 535, 540, 545, in a frame, e.g., frame 560. DPUs herein, e.g., DPU 610, may also configure a plurality of tile rows in the one or more layers, e.g., layers 510, 520, 530, 535, 540, 545, in a frame, e.g., frame 560.

Additionally, DPUs herein, e.g., DPU 610, may calculate a bandwidth compression ratio (CR) for each of a plurality of tile rows in one or more layers, e.g., layers 510, 520, 530, 535, 540, 545, in a frame, e.g., frame 560, where each of the one or more layers may be associated with one or more regions, e.g., regions 512, 514, 516, 522, 524, 526, 532, 536, 542, 546, in the frame. DPUs herein, e.g., DPU 610, may also overlay each of the plurality of tile rows with an adjacent tile row of the plurality of tile rows in the one or more layers, e.g., layers 510, 520, 530, 535, 540, 545. DPUs herein, e.g., DPU 610, may also determine a minimum bandwidth CR for the plurality of tile rows in each of the one or more regions associated with each of the one or more layers.

Further, DPUs herein, e.g., DPU 610, may determine a bandwidth CR for each of the one or more regions, e.g., regions 512, 514, 516, 522, 524, 526, 532, 536, 542, 546, associated with each of the one or more layers, e.g., layers 510, 520, 530, 535, 540, 545, based on the calculated bandwidth CR for the plurality of tile rows in the one or more layers. In some instances, the bandwidth CR for each of the one or more regions, e.g., regions 512, 514, 516, 522, 524, 526, 532, 536, 542, 546, associated with each of the one or more layers, e.g., layers 510, 520, 530, 535, 540, 545, may be determined by a DPU, e.g., DPU 610. DPUs herein, e.g., DPU 610, may also communicate the determined bandwidth CR for each of the one or more regions, e.g., regions 512, 514, 516, 522, 524, 526, 532, 536, 542, 546, associated with each of the one or more layers, e.g., layers 510, 520, 530, 535, 540, 545.

DPUs herein, e.g., DPU 610, may also determine whether each of the one or more layers, e.g., layers 510, 520, 530, 535, 540, 545, is a non-updating layer or an updating layer. In some aspects, the determined bandwidth CR for each of the one or more regions, e.g., regions 512, 514, 516, may correspond to a calculated bandwidth CR for a non-updating layer, e.g., layer 510. Also, the determined bandwidth CR for each of the one or more regions, e.g., regions 522, 524, 526, may correspond to a minimum bandwidth CR for an updating layer, e.g., layer 520.

Moreover, DPUs herein, e.g., DPU 610, may calculate a total bandwidth for each of the one or more regions, e.g., regions 512, 514, 516, 522, 524, 526, 532, 536, 542, 546, associated with each of the one or more layers, e.g., layers 510, 520, 530, 535, 540, 545, based on the determined bandwidth CR for each of one or more regions associated with each of the one or more layers. DPUs herein, e.g., DPU 610, may also combine the calculated total bandwidth for each of the one or more regions, e.g., regions 512, 514, 516, 522, 524, 526, 532, 536, 542, 546, in the one or more layers, e.g., layers 510, 520, 530, 535, 540, 545. In some aspects, the combined total bandwidth for each of the one or more regions, e.g., region 562, may correspond to a sum of a minimum bandwidth CR for each region in an updating layer, e.g., regions 512, 532, 542 in layers 510, 530, and 540, and a calculated bandwidth CR for each region in a non-updating layer, e.g., region 522 in layer 520.

DPUs herein, e.g., DPU 610, may also determine a total bandwidth for the frame, e.g., frame 560, based on the determined bandwidth CR for each of the one or more regions associated with the one or more layers. In some instances, the total bandwidth for the frame, e.g., frame 560, may be based on the calculated total bandwidth for each of the one or more regions in the frame. Also, the total bandwidth for the frame, e.g., frame 560, may correspond to a maximum total bandwidth of the one or more regions in the frame.

DPUs herein, e.g., DPU 610, may also monitor a bandwidth CR for each of the one or more regions, e.g., regions 522, 524, 526, associated with each of the one or more layers, e.g., layer 520, over a time period when each of the one or more layers is an updating layer. In some aspects, a minimum bandwidth CR for each of the one or more regions, e.g., regions 522, 524, 526, may be included in the total bandwidth determination when the minimum bandwidth CR is within a bandwidth CR range over the time period. Further, a previous bandwidth CR for each of the one or more regions, e.g., regions 522, 524, 526, may be included in the total bandwidth determination when a minimum bandwidth CR for each of the one or more regions is outside a bandwidth CR range over the time period.

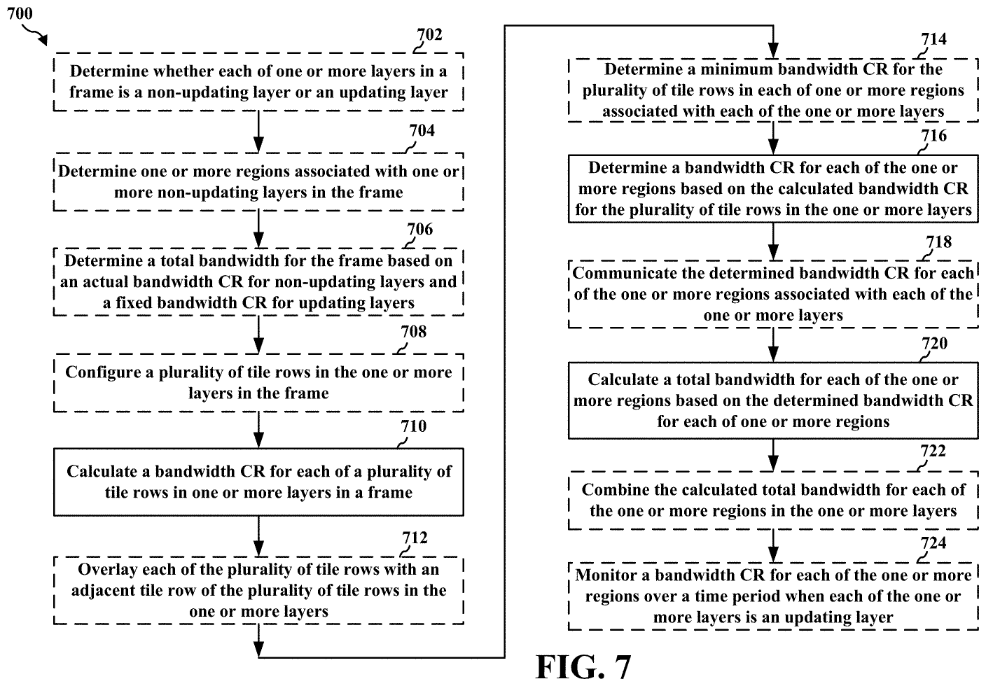

FIG. 7 illustrates an example flowchart 700 of an example method in accordance with one or more techniques of this disclosure. The method may be performed by an apparatus such as a display processor, a DPU, DPU hardware, DPU software, a GPU, or a CPU. At 702, the apparatus may determine whether each of one or more layers in a frame is a non-updating layer or an updating layer, as described in connection with the examples in FIGS. 3A, 3B, 4, 5A, 5B, and 6. At 704, the apparatus may determine one or more regions associated with one or more non-updating layers in the frame, as described in connection with the examples in FIGS. 3A, 3B, 4, 5A, 5B, and 6.

At 706, the apparatus may determine a total bandwidth for the frame based on an actual bandwidth CR for non-updating layers and a fixed bandwidth CR for updating layers, as described in connection with the examples in FIGS. 3A, 3B, 4, 5A, 5B, and 6. At 708, the apparatus may configure a plurality of tile rows in the one or more layers in the frame, as described in connection with the examples in FIGS. 3A, 3B, 4, 5A, 5B, and 6.

At 710, the apparatus may calculate a bandwidth compression ratio (CR) for each of a plurality of tile rows in one or more layers in a frame, where each of the one or more layers may be associated with one or more regions in the frame, as described in connection with the examples in FIGS. 3A, 3B, 4, 5A, 5B, and 6.

At 712, the apparatus may overlay each of the plurality of tile rows with an adjacent tile row of the plurality of tile rows in the one or more layers, as described in connection with the examples in FIGS. 3A, 3B, 4, 5A, 5B, and 6.

At 714, the apparatus may determine a minimum bandwidth CR for the plurality of tile rows in each of the one or more regions associated with each of the one or more layers, as described in connection with the examples in FIGS. 3A, 3B, 4, 5A, 5B, and 6.

At 716, the apparatus may determine a bandwidth CR for each of the one or more regions associated with each of the one or more layers based on the calculated bandwidth CR for the plurality of tile rows in the one or more layers, as described in connection with the examples in FIGS. 3A, 3B, 4, 5A, 5B, and 6. In some instances, the bandwidth CR for each of the one or more regions associated with each of the one or more layers may be determined by a DPU, as described in connection with the examples in FIGS. 3A, 3B, 4, 5A, 5B, and 6.

At 718, the apparatus may communicate the determined bandwidth CR for each of the one or more regions associated with each of the one or more layers, as described in connection with the examples in FIGS. 3A, 3B, 4, 5A, 5B, and 6.

In some aspects, the determined bandwidth CR for each of the one or more regions may correspond to a calculated bandwidth CR for a non-updating layer, as described in connection with the examples in FIGS. 3A, 3B, 4, 5A, 5B, and 6. Also, the determined bandwidth CR for each of the one or more regions may correspond to a minimum bandwidth CR for an updating layer, as described in connection with the examples in FIGS. 3A, 3B, 4, 5A, 5B, and 6.

At 720, the apparatus may calculate a total bandwidth for each of the one or more regions associated with each of the one or more layers based on the determined bandwidth CR for each of one or more regions associated with each of the one or more layers, as described in connection with the examples in FIGS. 3A, 3B, 4, 5A, 5B, and 6.

At 722, the apparatus may combine the calculated total bandwidth for each of the one or more regions in the one or more layers, as described in connection with the examples in FIGS. 3A, 3B, 4, 5A, 5B, and 6. In some aspects, the combined total bandwidth for each of the one or more regions may correspond to a sum of a minimum bandwidth CR for each region in an updating layer and a calculated bandwidth CR for each region in a non-updating layer, as described in connection with the examples in FIGS. 3A, 3B, 4, 5A, 5B, and 6.

In some instances, the total bandwidth for the frame may be based on the calculated total bandwidth for each of the one or more regions in the frame, as described in connection with the examples in FIGS. 3A, 3B, 4, 5A, 5B, and 6. Also, the total bandwidth for the frame may correspond to a maximum total bandwidth of the one or more regions in the frame, as described in connection with the examples in FIGS. 3A, 3B, 4, 5A, 5B, and 6.

At 724, the apparatus may monitor a bandwidth CR for each of the one or more regions associated with each of the one or more layers over a time period when each of the one or more layers is an updating layer, as described in connection with the examples in FIGS. 3A, 3B, 4, 5A, 5B, and 6. In some aspects, a minimum bandwidth CR for each of the one or more regions may be included in the total bandwidth determination when the minimum bandwidth CR is within a bandwidth CR range over the time period, as described in connection with the examples in FIGS. 3A, 3B, 4, 5A, 5B, and 6. Further, a previous bandwidth CR for each of the one or more regions may be included in the total bandwidth determination when a minimum bandwidth CR for each of the one or more regions is outside a bandwidth CR range over the time period, as described in connection with the examples in FIGS. 3A, 3B, 4, 5A, 5B, and 6.

In one configuration, a method or apparatus for display processing is provided. The apparatus may be a display processor, a DPU, DPU hardware, DPU software, a GPU, or a CPU or some other processor that can perform display processing. In one aspect, the apparatus may be the processing unit 120 within the device 104, or may be some other hardware within device 104 or another device. The apparatus may include means for calculating a bandwidth compression ratio (CR) for each of a plurality of tile rows in one or more layers in a frame, each of the one or more layers being associated with one or more regions in the frame. The apparatus may also include means for determining a bandwidth CR for each of the one or more regions associated with each of the one or more layers based on the calculated bandwidth CR for the plurality of tile rows in the one or more layers. The apparatus may also include means for determining a total bandwidth for the frame based on the determined bandwidth CR for each of the one or more regions associated with the one or more layers. The apparatus may also include means for calculating a total bandwidth for each of the one or more regions associated with each of the one or more layers based on the determined bandwidth CR for each of one or more regions associated with each of the one or more layers. The apparatus may also include means for combining the calculated total bandwidth for each of the one or more regions in the one or more layers. The apparatus may also include means for determining whether each of the one or more layers is a non-updating layer or an updating layer. The apparatus may also include means for overlaying each of the plurality of tile rows with an adjacent tile row of the plurality of tile rows in the one or more layers. The apparatus may also include means for determining a minimum bandwidth CR for the plurality of tile rows in each of the one or more regions associated with each of the one or more layers. The apparatus may also include means for communicating the determined bandwidth CR for each of the one or more regions associated with each of the one or more layers. The apparatus may also include means for monitoring a bandwidth CR for each of the one or more regions associated with each of the one or more layers over a time period when each of the one or more layers is an updating layer. The apparatus may also include means for determining the one or more regions associated with the one or more layers in the frame. The apparatus may also include means for configuring the plurality of tile rows in the one or more layers in the frame.

The subject matter described herein can be implemented to realize one or more benefits or advantages. For instance, the described display and/or graphics processing techniques can be used by a display processor, a DPU, DPU hardware, DPU software, a GPU, or a CPU or some other processor that can perform display processing to implement the refresh offset techniques described herein. This can also be accomplished at a low cost compared to other display or graphics processing techniques. Moreover, the display or graphics processing techniques herein can improve or speed up data processing or execution. Further, the display or graphics processing techniques herein can improve resource or data utilization and/or resource efficiency. Additionally, aspects of the present disclosure can utilize compression feedback in display processing in order to reduce power consumption.

In accordance with this disclosure, the term “or” may be interrupted as “and/or” where context does not dictate otherwise. Additionally, while phrases such as “one or more” or “at least one” or the like may have been used for some features disclosed herein but not others, the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. By way of example, and not limitation, such computer-readable media can comprise RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of interoperative hardware units, including one or more processors as described above, in conjunction with suitable software and/or firmware.

Various examples have been described. These and other examples are within the scope of the following claims.

1. A method of display processing, comprising:
calculating a bandwidth compression ratio (CR) for each of a plurality of tile rows in one or more layers in a frame, each of the one or more layers being associated with one or more regions in the frame;
determining a bandwidth CR for each of the one or more regions associated with each of the one or more layers based on the calculated bandwidth CR for the plurality of tile rows in the one or more layers;
calculating a total bandwidth for each of the one or more regions based on the determined bandwidth CR for each of the one or more regions; and
combining the calculated total bandwidth for each of the one or more regions in the one or more layers, wherein the combined total bandwidth for each of the one or more regions corresponds to a sum of a minimum bandwidth CR for each region in an updating layer of the one or more layers and a calculated bandwidth CR for each region in a non-updating layer of the one or more layers.

2. The method of claim 1, further comprising:
determining a total bandwidth for the frame based on an actual bandwidth CR for each non-updating layer of the one or more layers and a fixed bandwidth CR for each updating layer of the one or more layers.

3. (canceled)

4. (canceled)

5. The method of claim 2, wherein the total bandwidth for the frame is based on the calculated total bandwidth for each of the one or more regions in the frame.

6. The method of claim 5, wherein the total bandwidth for the frame corresponds to a maximum total bandwidth of the one or more regions in the frame.

7. The method of claim 1, further comprising:
determining whether each of the one or more layers is a non-updating layer or an updating layer.

8. The method of claim 7, wherein the determined bandwidth CR for each of the one or more regions corresponds to a calculated bandwidth CR for a non-updating layer.

9. The method of claim 7, wherein the determined bandwidth CR for each of the one or more regions corresponds to a minimum bandwidth CR for an updating layer.

10. The method of claim 1, further comprising:
overlaying each of the plurality of tile rows with an adjacent tile row of the plurality of tile rows in the one or more layers.

11. The method of claim 1, further comprising:
determining a minimum bandwidth CR for the plurality of tile rows in each of the one or more regions associated with each of the one or more layers.

12. The method of claim 1, further comprising:
communicating the determined bandwidth CR for each of the one or more regions associated with each of the one or more layers.

13. The method of claim 1, further comprising:
monitoring a bandwidth CR for each of the one or more regions associated with each of the one or more layers over a time period when each of the one or more layers is an updating layer.

14. The method of claim 13, wherein a minimum bandwidth CR for each of the one or more regions is included in the total bandwidth determination when the minimum bandwidth CR is within a bandwidth CR range over the time period.

15. The method of claim 13, wherein a previous bandwidth CR for each of the one or more regions is included in the total bandwidth determination when a minimum bandwidth CR for each of the one or more regions is outside a bandwidth CR range over the time period.

16. The method of claim 1, further comprising:
determining the one or more regions associated with the one or more layers in the frame.

17. The method of claim 1, further comprising:
configuring the plurality of tile rows in the one or more layers in the frame.

18. The method of claim 1, wherein the bandwidth CR for each of the one or more regions associated with each of the one or more layers is determined by a display processing unit (DPU).

19. An apparatus for display processing, comprising:
a memory; and
at least one processor coupled to the memory and configured to:
calculate a bandwidth compression ratio (CR) for each of a plurality of tile rows in one or more layers in a frame, each of the one or more layers being associated with one or more regions in the frame;
determine a bandwidth CR for each of the one or more regions associated with each of the one or more layers based on the calculated bandwidth CR for the plurality of tile rows in the one or more layers;
calculate a total bandwidth for each of the one or more regions based on the determined bandwidth CR for each of the one or more regions; and
combine the calculated total bandwidth for each of the one or more regions in the one or more layers, wherein the combined total bandwidth for each of the one or more regions corresponds to a sum of a minimum bandwidth CR for each region in an updating layer of the one or more layers and a calculated bandwidth CR for each region in a non-updating layer of the one or more layers.

20. The apparatus of claim 19, wherein the at least one processor is further configured to:
determine a total bandwidth for the frame based on an actual bandwidth CR for each non-updating layer of the one or more layers and a fixed bandwidth CR for each updating layer of the one or more layers.

21. (canceled)

22. (canceled)

23. The apparatus of claim 20, wherein the total bandwidth for the frame corresponds to a maximum total bandwidth of the one or more regions in the frame.

24. The apparatus of claim 19, wherein the at least one processor is further configured to:
determine whether each of the one or more layers is a non-updating layer or an updating layer;
wherein the determined bandwidth CR for each of the one or more regions corresponds to a calculated bandwidth CR for a non-updating layer; and
wherein the determined bandwidth CR for each of the one or more regions corresponds to a minimum bandwidth CR for an updating layer.

25. The apparatus of claim 19, wherein the at least one processor is further configured to:
overlay each of the plurality of tile rows with an adjacent tile row of the plurality of tile rows in the one or more layers.

26. The apparatus of claim 19, wherein the at least one processor is further configured to:
determine a minimum bandwidth CR for the plurality of tile rows in each of the one or more regions associated with each of the one or more layers.

27. The apparatus of claim 19, wherein the at least one processor is further configured to:
monitor a bandwidth CR for each of the one or more regions associated with each of the one or more layers over a time period when each of the one or more layers is an updating layer.

28. The apparatus of claim 27, wherein a minimum bandwidth CR for each of the one or more regions is included in the total bandwidth determination when the minimum bandwidth CR is within a bandwidth CR range over the time period;
wherein a previous bandwidth CR for each of the one or more regions is included in the total bandwidth determination when a minimum bandwidth CR for each of the one or more regions is outside a bandwidth CR range over the time period.

29. An apparatus for display processing, comprising:
means for calculating a bandwidth compression ratio (CR) for each of a plurality of tile rows in one or more layers in a frame, each of the one or more layers being associated with one or more regions in the frame;
means for determining a bandwidth CR for each of the one or more regions associated with each of the one or more layers based on the calculated bandwidth CR for the plurality of tile rows in the one or more layers;
means for calculating a total bandwidth for each of the one or more regions based on the determined bandwidth CR for each of the one or more regions; and
means for combining the calculated total bandwidth for each of the one or more regions in the one or more layers, wherein the combined total bandwidth for each of the one or more regions corresponds to a sum of a minimum bandwidth CR for each region in an updating layer of the one or more layers and a calculated bandwidth CR for each region in a non-updating layer of the one or more layers.

30. A non-transitory computer-readable medium storing computer executable code for display processing, the code when executed by a processor causes the processor to:
calculate a bandwidth compression ratio (CR) for each of a plurality of tile rows in one or more layers in a frame, each of the one or more layers being associated with one or more regions in the frame;
determine a bandwidth CR for each of the one or more regions associated with each of the one or more layers based on the calculated bandwidth CR for the plurality of tile rows in the one or more layers;
calculate a total bandwidth for each of the one or more regions based on the determined bandwidth CR for each of the one or more regions; and
combine the calculated total bandwidth for each of the one or more regions in the one or more layers, wherein the combined total bandwidth for each of the one or more regions corresponds to a sum of a minimum bandwidth CR for each region in an updating layer of the one or more layers and a calculated bandwidth CR for each region in a non-updating layer of the one or more layers.
